(19) United States
(12) Patent Application Publication
(10) Pub. No.: US 2015/0104755 A1
(43) Pub. Date: Apr. 16, 2015

(54) WINGED IMPLANT

(71) Applicant: Cortex Dental Implants Industries Ltd., Shlomi (IL)

(72) Inventors: Zvi Laster, Poriya Elite (IL); Ole T. Jensen, Englewood, CO (US); Meir Mamraev, Rishon LeZion (IL)

(73) Assignee: Cortex Dental Implants Industries Ltd., Shlomi (IL)

(21) Appl. No.: 14/575,208

(22) Filed: Dec. 18, 2014

Related U.S. Application Data
(63) Continuation-in-part of application No. 13/603,461, filed on Sep. 5, 2012, now abandoned.
Application No. 13/603,461 is a continuation-in-part of application No. 12/926,286, filed on Nov. 8, 2010, now abandoned.
(60) Provisional application No. 61/398,331, filed on Jun. 24, 2010.
(60) Provisional application No. 61/283,976, filed on Dec. 11, 2009.

(51) Int. Cl. A61C 8/00

(52) U.S. Cl. CPC A61C 8/0024; A61C 8/005
USPC 433/174

(57) ABSTRACT

A winged implant for implantation within osseous tissue or bone, comprising an implant body having a first external threading, and a second external threading parallel to the first external threading; a first wing member projecting radially outwardly of said implant body, as a smooth continuation of said first external threading; a second wing member projecting radially outwardly of said implant body, as a smooth continuation of said second external threading, wherein said first wing member and said second wing member extend annularly around said implant body.

### CROSS-REFERENCE TO RELATED APPLICATIONS

This patent application is a Continuation-In-Part of co-pending U.S. patent application Ser. No. 13/603,461, entitled “Winged Implant”, filed on Sep. 5, 2012, which is a Continuation-In-Part of abandoned U.S. patent application Ser. No. 12/926,286, entitled “Winged Implant”, filed on Nov. 8, 2010, which is a non-provisional application claiming priority to expired U.S. Provisional Patent Application Ser. No. 61/398,331, filed Jun. 24, 2010, entitled “Winged Implant”, and expired U.S. Provisional Patent Application Ser. No. 61/283,976, filed Dec. 11, 2009, entitled “Winged Implant”, all which are incorporated herein by reference in their entirety.

### FIELD OF THE INVENTION

The present invention relates to a winged implant, which is adapted to be inserted into and/or applied to bone and/or osseous tissue during a dental implant procedure, wherein, in addition to external threads disposed upon the external periphery thereof for threaded insertion and engagement within the bone or osseous tissue, the winged implant also comprises at least one wing member or element, having a diametrical extent which is substantially larger than the diametrical extent of the external threads, as determined at the crest portions thereof, for stabilizing the implant within the bone or osseous tissue.

### BACKGROUND OF THE INVENTION

Generally, implants are adapted to be used during an implant procedure. During implant procedures, a crater may be formed, which may initially be filled with congealing blood and bone fragments. The crater may generally have a frusto-conical shape.

As may be customary, implant procedures may take place immediately or relatively soon after the crater is formed. Thus, the implant may be only partially lodged within solid bone, with a considerable portion thereof extending substantially unsupported outwardly from the crater so that, relative to the crater, the implant comprises a cantilevered structure. Such a mode of operation may compromise the implant stability, as is well known in the art, and as may be measured as an ISQ or Implant Stability Quotient Improved implant stability may enhance osseointegration. Such a requirement for stability is greatly desired, particularly if immediate loading is performed subsequent to the implant procedure.

In the French Patent FR 2645011 to Florian, entitled “Bone Implant Eyebolt Which Is Intended On The One Hand To Form An Artificial Tooth Root And On The Other Hand To Reduce Bone Fractures, And Which Can Be Used In Ear, Nose And Throat Treatment”, there is described, inter alia, a device for fixing an implant eyebolt to a bone in order to hold a tooth prosthesis to the bone and to reduce bone fractures. It consists of a cylinder made of pure titanium for medical use, it is provided in its upper part with a flat-head screw having a slot so that it can be maneuvered by means of a screwdriver, and is provided within its lower part with two cylindrical pins for locking the implant to the bone. Prior to the positioning of this implant eye-bolt, a bore is drilled with a bone-drill bur having the dimension of the eyebolt with a stop, a grinding bur with a stop is used for the lateral and circular grinding or burring of the lower part, and a bone fissure bur with a stop for burring two small lateral walls. The device makes it possible to hold in position, by means of the implant, a tooth prosthesis, and to reduce bone fractures by locking the implant eyebolt to the bone, the device further permitting osseointegration in the parts left empty by the burring and grinding.

In U.S. Pat. No. 4,722,687 to Scortecci, entitled “Dental Implant For The Securement Of Fixed Dental Prostheses”, there is described, among other things, a dental implant that serves as its own cutting tool for forming a T-shaped slot within a human tooth so as to receive the implant, and comprises a flat circular wheel having cutting teeth upon its periphery. An elongated shaft is secured coaxially to the wheel and has milling surfaces thereon that extend from the wheel a distance which is several times greater than the thickness of the wheel and several times greater than the diameter of the milling surfaces. The diameter of the wheel is several times greater than the diameter of the milling surfaces. A portion of the shaft extending beyond the milling surfaces in a direction away from the wheel permits the releasable securement of the implant to a dental drill.

In United States Patent US2006/110707 to Perez et al., entitled “Dental Implant”, there is described, inter alia, a rounded, mill-like member having an external diameter d1 centered upon the implant's main axis and co-axial with a secondary, horizontal axis located at a right angle with the implant's main axis, wherein the mill-like member is characterized by a jagged milling surface at the distal end thereof facing the jawbone. An abutment is located at the proximal end and extends from the mill-like member towards the oral cavity, and the drill-like member is adapted to penetrate perpendicularly to a predetermined depth so as to accommodate an intrabone portion of the jawbone, while the mill-like member is fixated in a diameter d1 to a supra-bone portion of the jawbone. Surprisingly, the dental implant according to this patented invention is endowed with an improved durability to the forces generated within the oral activity, such as, for example, mastication or the like, and is resistant against perpendicular forces as well as lateral forces, yet the insertion thereof into the patient's jawbone is performed in a single-step operation and does not require cutting a second incision or more in the patient's mouth, thus combining the advantages of vertical penetrating implants, such as, for example, short treatment and healing process times and less risk of infection, with the strength and durability of laterally inserted implants, achieved as a result of the efficient fastening mechanism provided for securing the implant in place to the bone.

Lastly, in German Patent DE4142584 to Lang, entitled “Dental Implant For Retaining False Tooth—Has Sickle Shaped Ribs With Sharp Edges Arranged In Helix”, there is described a dental implant for retaining a false tooth which has a cylindrical upper part and a tapered lower part. The lower part has a number of sickle shaped ribs which project radially outwardly. The ribs are positioned so that they lie upon a helix which winds around the tapered lower part. When the implant is inserted into the alveole of the patient's jaw, these ribs cut into the walls of the alveole and hold the implant in place. The upper part of the implant has a tapped hole to receive the screwed shank of the false tooth. The implant for retaining the false tooth need not be inserted to the full depth of the alveole.

It would be desirable to have a wing implant that, when attempting unscrewing, will tend to resist it. Furthermore, it would be desirable to enhance the implant stability, as may be measured as an ISQ. Therefore, there currently exists a need in the industry for an implant and an associated method of implanting the implant that may tend to resist any application of an unscrewing torque applied thereto, and which may likewise tend to resist bending moments and forces applied thereto. This may be attained in accordance with the principles and teachings of the present invention.

### SUMMARY OF THE INVENTION

In the following disclosure, aspects thereof are described and illustrated in conjunction with systems and methods that are meant to be exemplary and illustrative and not limiting in scope.

The present invention is broadly concerned with an implant that is designed for implantation, more specifically within human and/or animal tissues, and to a method of implanting the associated implant. With respect to the implant per se, the implant comprises an implant body, which is generally shaped as a self-tapping screw, and which can be tapped into bone tissues during an implant procedure, and is also capable of resisting, or tending to resist, sideways forces, after the implant has set, that is, after osseointegration. The implant body has external threads formed around the external periphery thereof for cutting or tapping into the bone or osseous tissue, and furthermore comprises at least one wing member which extends radially outwardly so as to generally extend transversely to, and away from, the longitudinal axis of the implant body.

In a first aspect of the present invention, a winged implant for implantation within osseous tissue or bone is provided, the implant comprising: an implant body having a first external threading, and a second external threading parallel to the first external threading; a first wing member projecting radially outwardly of said implant body, as a continuation of said first external threading; a second wing member projecting radially outwardly of said implant body, as a continuation of said second external threading; wherein said first wing member and said second wing member extend annularly around said implant body.

In some embodiments, at least one of said first wing member and said second wing member extends continuously around said implant body.

In some embodiments, at least one of said first wing member and said second wing member extend discontinuously around said implant body.

In some embodiments, at least one of said first wing member and said second wing member has a cross-sectional configuration narrowing from a wing root to a wing tip.

In some embodiments, at least one of said first wing member and said second wing member comprises a plurality of wing sections.

In some embodiments, each one of said plurality of wing sections is located at a different axial position as measured longitudinally from said implant body.

In some embodiments, each one of said plurality of wing sections is staggered axially relative to said implant body.

In some embodiments, each one of said plurality of wing sections is staggered circumferentially relative to said implant body.

In some embodiments, each one of said plurality of wing sections is staggered circumferentially relative to said implant body, and wherein said plurality of circumferentially staggered wing sections are disposed upon a helix.

In some embodiments, the implant body has a distal end portion with a socket portion so as to accommodate a tool for imparting rotation to said implant.

In some embodiments, the implant body is formed with a threaded receptacle for receiving a threaded screw or bolt.

In some embodiments, the implant body further comprises a fluke so as to facilitate initial cutting into the bone or osseous tissue.

In a second aspect of the present invention, a method for implanting an implant within osseous tissue or bone with enhanced stability is provided, the method comprising the steps of: providing a winged implant, comprising: an implant body having a first external threading, and a second external threading parallel to the first external threading; a first wing member projecting radially outwardly of said implant body, as a continuation of said first external threading; a second wing member projecting radially outwardly of said implant body, as a continuation of said second external threading, wherein said first wing member and said second wing member extend annularly around said implant body; and rotating said implant body in a threading-in direction during an implant procedure, wherein said implant body is implanted within the osseous tissue or bone as a result of said first external threading and said second external threading effectively cutting and defining female threads within the osseous tissue or bone, and wherein said first wing member and said second wing member also cut into the osseous tissue or bone so as to support said implant body, thereby enhancing the stability of said implant within the osseous tissue or bone.

In some embodiments, the implant body has a distal end portion with a socket portion such that the rotation of the implant body is carried out with a tool accommodated in the socket portion.

In a third aspect of the present invention, a method for implanting an implant within osseous tissue or bone with enhanced stability is provided, the method comprising the steps of: providing an implant body having a protruding segment extending annularly around said implant body; and rotating said implant body in a threading-in direction during an implant procedure, wherein said protruding segment cuts into the osseous tissue or bone so as to support said implant body, thereby enhancing the stability of said implant within the osseous tissue or bone.

In some embodiments, the further comprises corrugating the implant body with a first annular corrugation to create an intermediate external threading and an intermediate wing member.

In some embodiments, the further comprises corrugating the implant body with a second annular corrugation to create a first external threading, a first wing member, a second external threading, and a second wing member.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the specification, including definitions, will control. In addition, the materials, methods, and examples are illustrative only and not intended to be limiting.

### BRIEF DESCRIPTION OF THE DRAWINGS

Embodiments are herein described, by way of example only, with reference to the accompanying drawings. With specific reference now to the drawings in detail, it is stressed that the particulars shown are by way of example and for purposes of illustrative discussion of the preferred embodiments, and are presented in the cause of providing what is believed to be the most useful and readily understood description of the principles and conceptual aspects of the embodiments. In this regard, no attempt is made to show structural details in more detail than is necessary for a fundamental understanding of the invention, the description taken with the drawings making apparent to those skilled in the art how the several forms of the invention may be embodied in practice.

In the drawings:

FIG. 1A is a schematic longitudinal cross-sectional view of a first embodiment of a winged implant, constructed in accordance with the principles and teachings of the present invention, as implanted within a tissue, according to an exemplary embodiment.

FIG. 1B is a schematic longitudinal cross-sectional view of the first embodiment of the winged implant, to be implanted with in a tissue, as shown in FIG. 1A, according to an exemplary embodiment.

FIG. 2 is a side view of the first embodiment of the implant, as illustrated within FIGS. 1A and 1B, wherein the wing member has a rhomboid cross-sectional configuration, according to an exemplary embodiment.

FIG. 3 is a side view of a second embodiment of a winged implant wherein the wing member has a circular cross-sectional configuration and the wing member comprises a cylinder, according to an exemplary embodiment.

FIG. 4 is a side view of a third embodiment of a winged implant member wherein the wing member has a circular cross-sectional configuration and the wing member comprises a frusto-conical structure, according to an exemplary embodiment.

FIG. 5 is a side view of a fourth embodiment of a winged implant wherein the wing member has a teardrop-shaped cross-sectional configuration, according to an exemplary embodiment.

FIG. 6 is a side view of a fifth embodiment of a winged implant wherein the wing member has a trigon cross-sectional configuration, according to an exemplary embodiment.

FIG. 7 is a side view of a sixth embodiment of a winged implant wherein the wing member has an ellipsoid cross-sectional configuration, according to an exemplary embodiment.

FIG. 8 is a side view of a seventh embodiment of a winged implant wherein the wing member has a triangular cross-sectional configuration, according to an exemplary embodiment.

FIG. 9 is a side view of an eighth embodiment of a winged implant wherein the wing member has a square-shaped cross-sectional configuration, according to an exemplary embodiment.

FIG. 10 is a partial, downwardly directed perspective view of a winged implant having a modified wing member with respect to the winged implant shown schematically in FIG. 9, wherein the wing member has a support structure operatively associated therewith, according to an exemplary embodiment.

FIG. 11A is a partial longitudinal cross-sectional view of a winged implant illustrating a first variation of the cross-sectional configuration of the wing member of the implant body, according to an exemplary embodiment.

FIG. 11B is a partial longitudinal cross-sectional view of a winged implant illustrating a second variation of the cross-sectional configuration of the wing member of the implant body, according to an exemplary embodiment.

FIG. 12 is a top plan view of a ninth embodiment of a winged implant constructed in accordance with the principles and teachings of the present invention, wherein the wing member comprises a plurality of arcuately shaped wing members disposed within a circumferential array around the distal end portion of the implant body, according to an exemplary embodiment.

FIG. 13 is a partial, side, upwardly directed perspective view of the ninth embodiment winged implant illustrated within FIG. 12, according to an exemplary embodiment.

FIG. 14 is a partial, downwardly directed perspective view of the winged implant illustrated within FIGS. 12 and 13, according to an exemplary embodiment.

FIG. 15 is a plan perspective view of the winged implant illustrated within FIGS. 12-14, according to an exemplary embodiment.

FIG. 16 is a schematic view of a tenth embodiment of a winged implant wherein the wing member comprises a single continuous annular or circumferentially extending wing member which is spirally oriented so as to effectively be a smooth continuous structure of the uppermost one of the external threads disposed upon the external peripheral surface of the implant body, according to an exemplary embodiment.

FIG. 17 is an eleventh embodiment of a winged wherein the wing member comprises a pair of discontinuous annular or circumferentially extending wing members which are spirally oriented so as to effectively define smooth continuous structures of the uppermost one of the external threads disposed upon the external peripheral surface of the implant body, according to an exemplary embodiment.

FIG. 18 is a view similar to that of FIG. 13 showing, however, the tenth embodiment of the winged implant as illustrated within FIG. 16, according to an exemplary embodiment.

FIG. 19 is a view similar to that of FIG. 14 showing, however, the tenth embodiment of the winged implant as illustrated within FIG. 16, according to an exemplary embodiment.

FIG. 20 is a view similar to that of FIG. 15 showing, however, the tenth embodiment of the winged implant as illustrated within FIG. 16, according to an exemplary embodiment.

FIG. 21 is a schematic perspective view of a twelfth embodiment of a winged implant wherein the wing member comprises two parallel continuous annular or circumferentially extending wing members which are effectively a smooth continuous structure of the parallel external threads disposed upon the external peripheral surface of the implant body, according to an exemplary embodiment.

FIG. 22A illustrates a frontal view of the twelfth embodiment of the winged implant as illustrated within FIG. 21 in an initial state, according to an exemplary embodiment.

FIG. 22B illustrates a frontal view of the twelfth embodiment of the winged implant as illustrated within FIG. 21 in an intermediate state, according to an exemplary embodiment.

FIG. 22C illustrates a frontal view of the twelfth embodiment of the winged implant as illustrated within FIG. 21 in a final state.

FIG. 23A illustrates a perspective view of the twelfth embodiment of the winged implant as illustrated within FIG. 21 in an intermediate state, according to an exemplary embodiment.

FIG. 23B illustrates a perspective view of the twelfth embodiment of the winged implant as illustrated within FIG. 21 in a final state.

### DESCRIPTION OF THE PREFERRED EMBODIMENTS

Before explaining at least one embodiment in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

For clarity, non-essential elements were omitted from some of the drawings.

In a preferred embodiment, a dental implant is provided and comprises an implant body having a first external threading, and a second external threading, disposed around the external peripheral surface of the implant body. The first external threading and the second external threading are disposed parallel to each other, such that a continuous annular wing member is created and continuing from each of these external threads. The first external threading continues as a first wing member and the second external threading continues as a second wing member. Since the first external threading and the second external threading are disposed parallel to each other, the first wing member and the second wing member are also disposed parallel to each other. It is also appreciated that the annular wing members may engage and embed themselves into the bone and/or osseous tissue portion of the oral cavity so as to stabilize the implant within the implantation site. It should be noted that additional features to this preferred embodiment are described hereinafter.

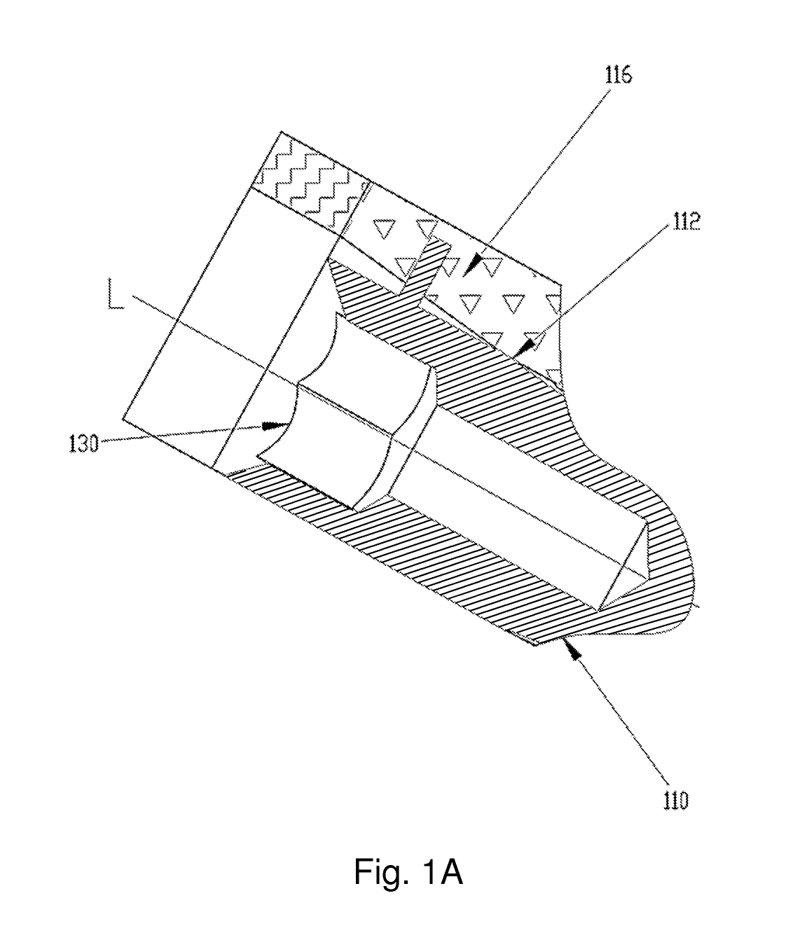

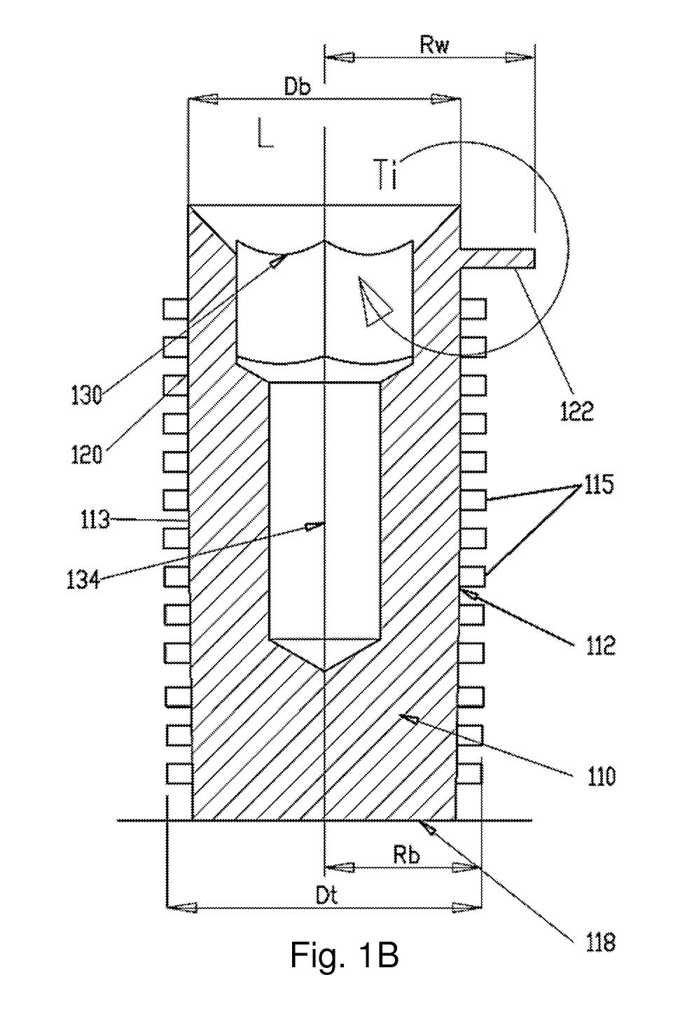

Reference is initially directed to FIG. 1A. FIG. 1A discloses a first embodiment of a winged implant 110 which is designed to be implanted into a substrate 116 wherein such substrates 116 may include, for example, bone or osseous tissues. With reference being additionally made to FIG. 1B, the winged implant 110 is shown to comprise an implant body 112 which has a generally cylindrical and/or frusto-conical configuration and which comprises a body core 113 having a predetermined external diameter Db. The implant body comprises an apical end 118 and a distal end 120, and a longitudinal axis L extends through the implant body 112 from the apical end 118 to the distal end 120. A screwing-in direction Ti is defined around the longitudinal axis L, and external threads 115 are disposed upon the external periphery of the implant body 112 such that the implant body 112 cuts into and effectively threadingly engages and embeds itself within the substrate 116 when the implant body 112 is inserted into the substrate 116 as a result of being rotated relative to the substrate 116. It is shown that the diametrical extent of the external threads 115, as measured at their crest portions, is denoted by Dt which is larger or greater than the diametrical extent Db of the implant body 112.

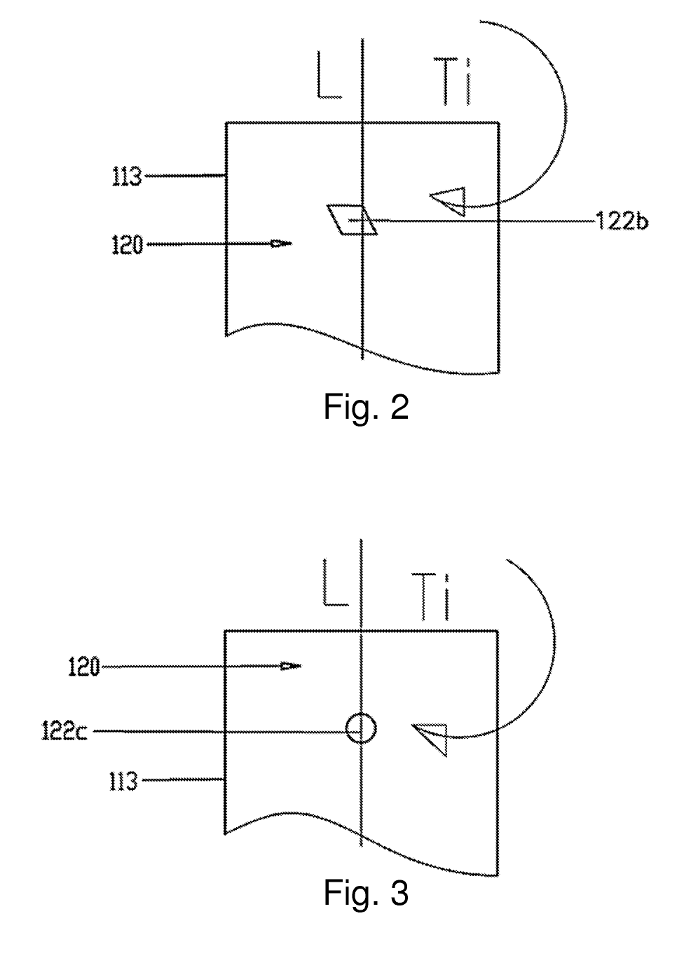

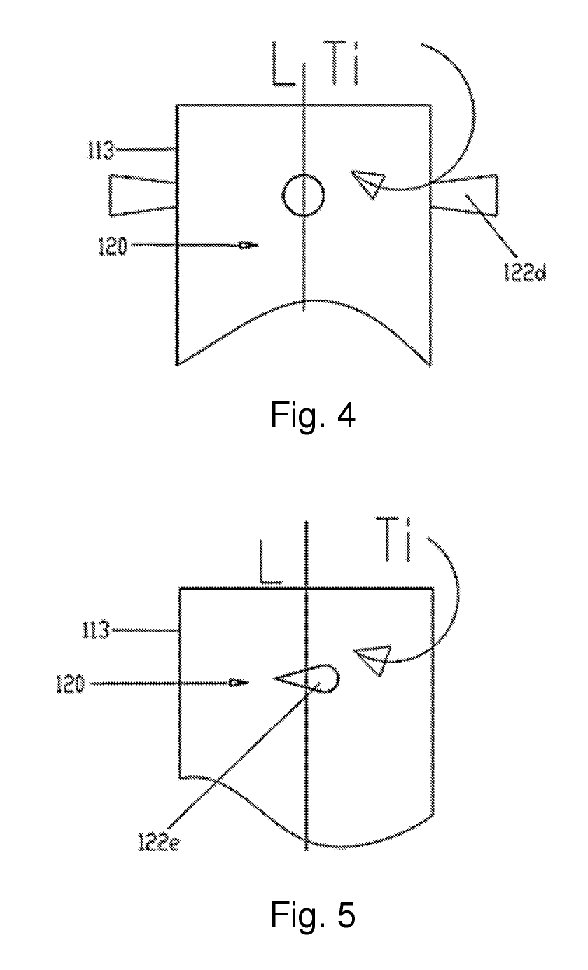

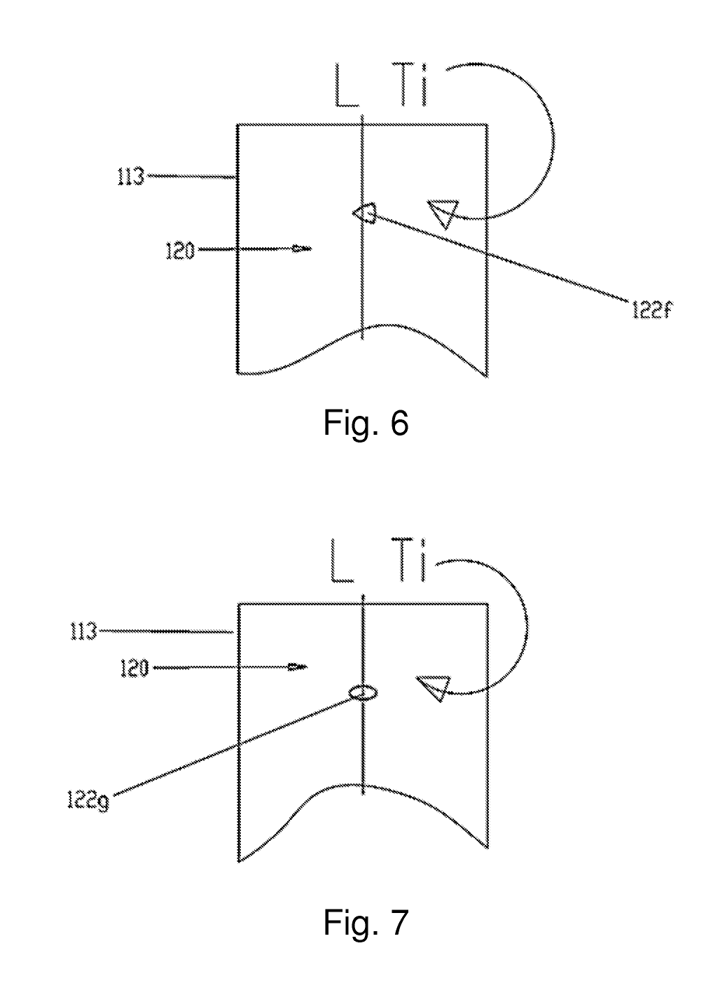

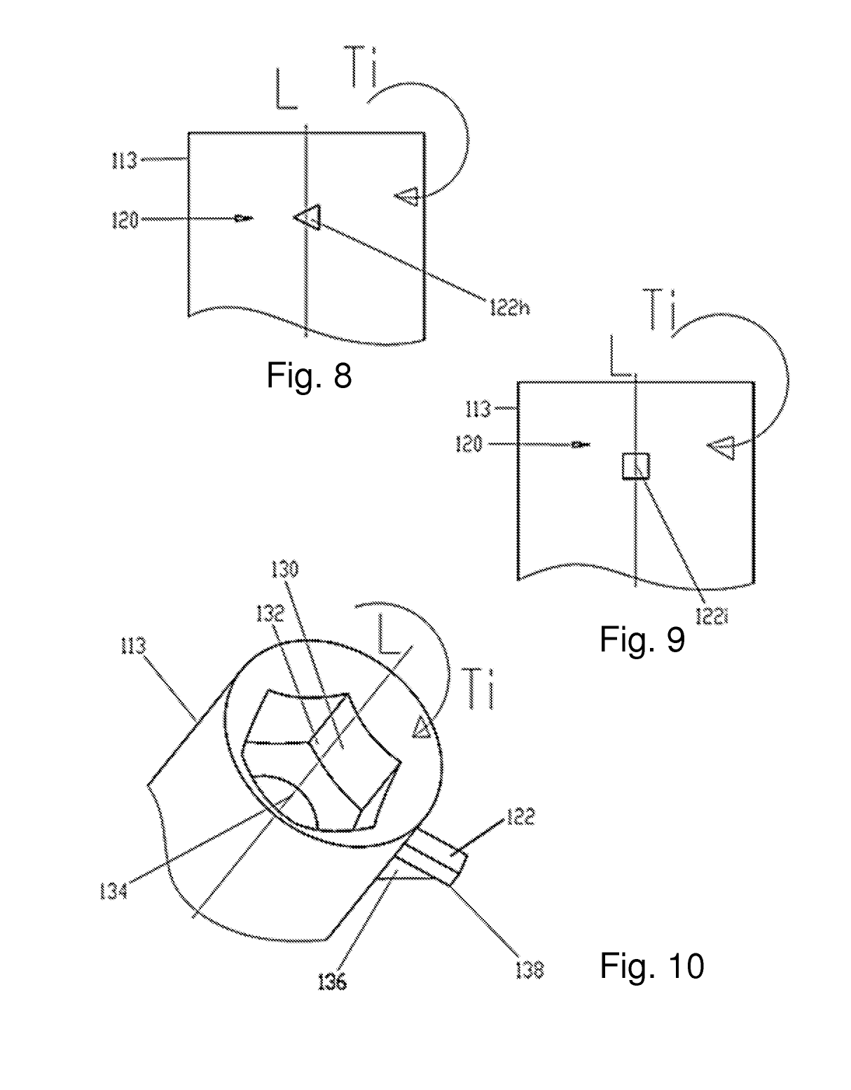

It is also shown that the distal end 120 of the winged implant body 112 has at least one wing member 122 which extends generally radially outwardly from the distal end 120 of the winged implant body 112. The at least one wing member 122 may have any desirable cross-sectional configuration, such as, for example, and for illustrative purposes only, as illustrated by means of the different embodiments illustrated within FIGS. 2 to 9, the exemplary wing members having cross-sections as shown, wherein similar components are denoted by similar reference numbers subsequently denoted by subscript letter following each exemplary cross-sectional wing component. More particularly, FIG. 2 schematically illustrates a wing member section 122b having a rhomboid cross-sectional configuration, FIG. 3 schematically illustrates a wing member section 122c, having a circular cross-sectional configuration, FIG. 4 schematically illustrates a wing member section 122d having a frusto-conical cross-sectional configuration, FIG. 5 schematically illustrates a wing member section 122e having a teardrop-shaped cross-sectional configuration, FIG. 6 schematically illustrates a wing member section 122f having a trigon-shaped cross-sectional configuration, FIG. 7 schematically illustrates a wing member section 122g having an ellipsoid cross-sectional configuration, FIG. 8 schematically illustrates a wing member section 122h having a triangular cross-sectional configuration, and FIG. 9 schematically illustrates a wing member section 122i having a square-shaped cross-sectional configuration.

As may be readily appreciated from FIGS. 1A, 1B, 10, 11A, 11B, 12, and 14, the winged implant body 112 may have a depression 130 extending axially inwardly from its distal end 120, wherein the depression 130 may comprise a hex-shaped socket 132 for receiving a suitably shaped rotary tool. Additionally, the winged implant body 112 may be formed with an axially oriented threaded receptacle 134 for receiving a threaded screw or bolt (not shown). FIG. 10 further illustrates that the at least one wing member 122 may further have a wing support 136 which extends radially inwardly from the radially outermost end 138 of the at least one wing member 122 so as to terminate upon the distal end 120 of the implant body 112.

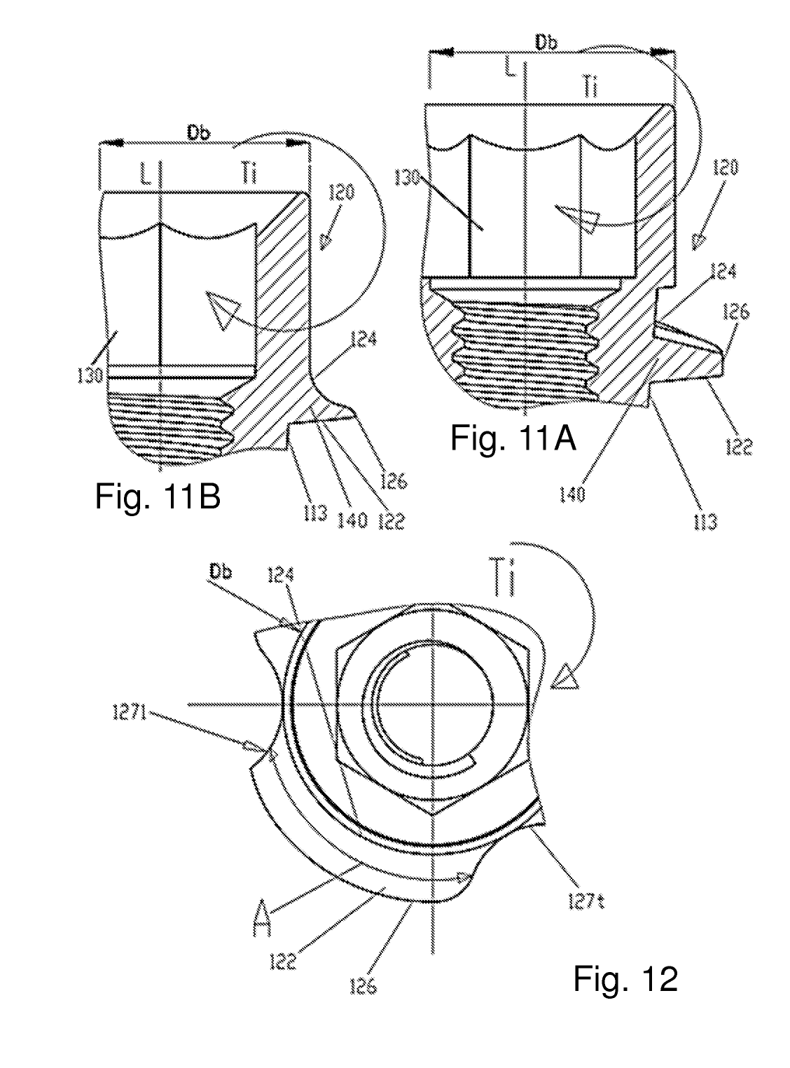

Similarly, other possible embodiments of the winged implant 110 are further schematically illustrated within FIGS. 11A to 15. For example, FIG. 11A shows a longitudinal cross-section through the distal end 120 of the winged implant 110 wherein the wing cross-section 140 of the at least one wing member 122 is illustrated. The wing cross-section 140 may be trapezoidal in shape having a wide wing root 124 wherein the wing member 122 tapers towards the narrower wing tip 126. As can readily be seen from FIG. 1B, the at least one wing member 122 has a diametrical or radial extent Rw that is substantially larger than the diametrical extent Db or radial extent Rb of the implant body 112, and the diametrical or radial extent Rw of the wing member 122 is also substantially larger than the diametrical or radial extent Dt of the external threads 115. More particularly, the diametrical or radial extent Rw of the wing member 122 may be at least 20% larger than the diametrical or radial extent Rb of the implant body 112.

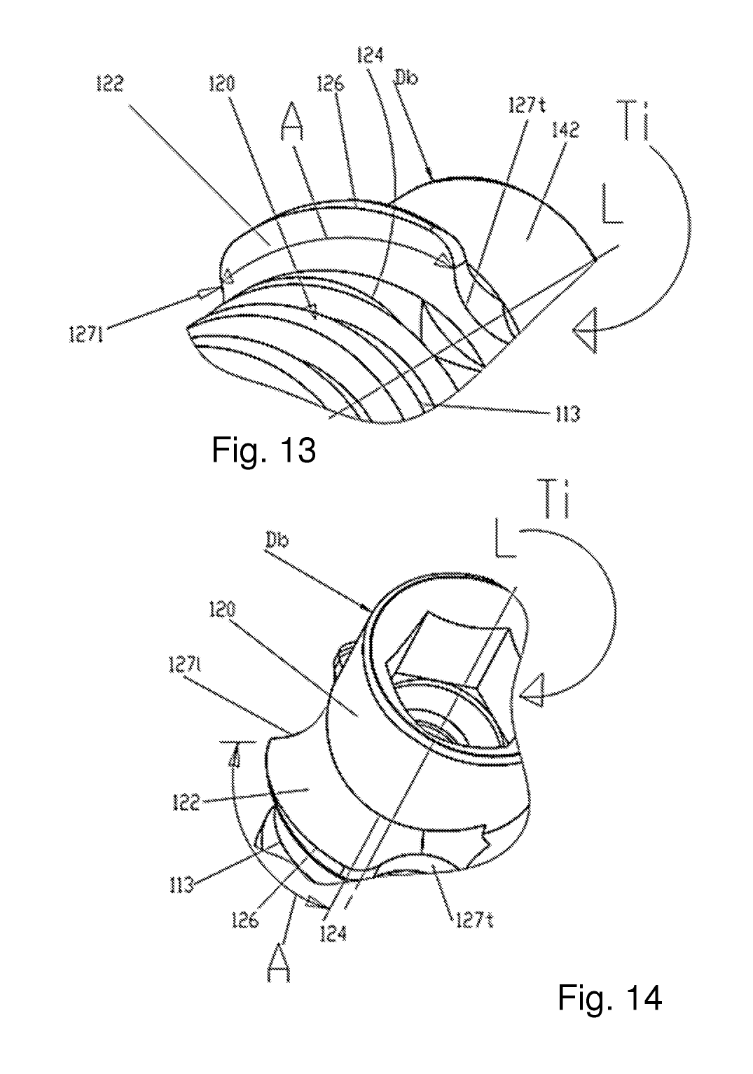

In addition, it is noted that the wing member 122 may generally follow a spiral or helical path along the outer periphery 142 of the distal end 120 of the winged implant 110, as shown in FIG. 13, and is preferably smoothly integrated into the uppermost thread of the external threads 115. More particularly, as can be seen from FIG. 11B, the wing tip 126 of the at least one wing member 122 may be narrowed further so as to smoothly integrate into the external threads 115 and thereby facilitate the threading-in of the winged implant 110.

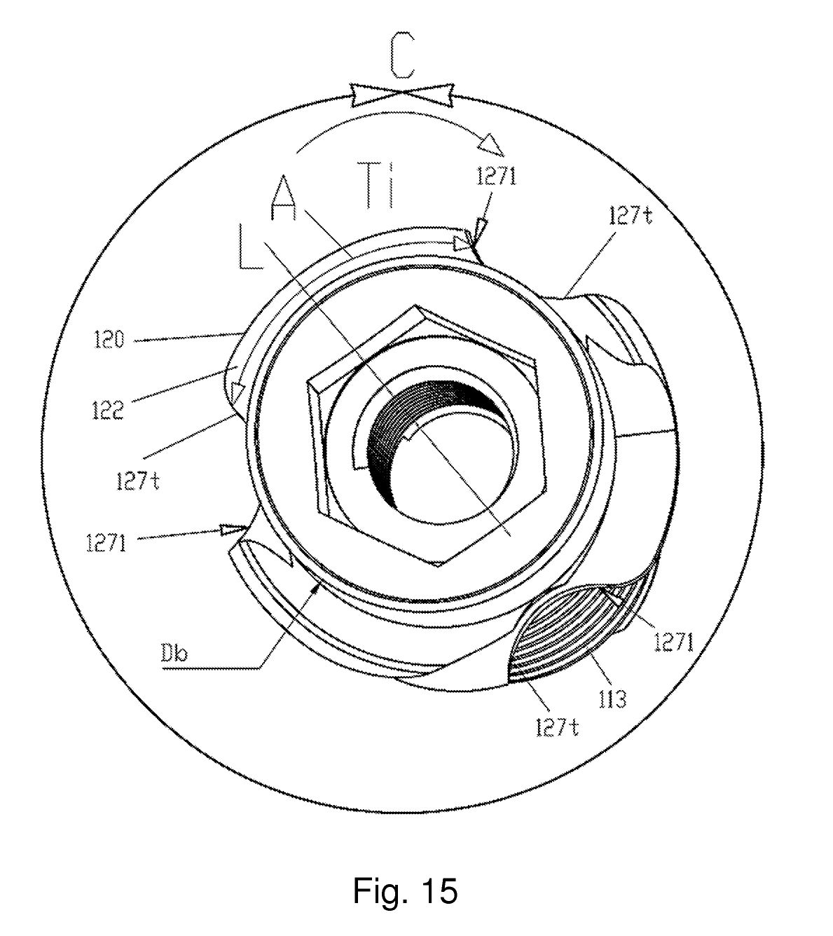

Continuing still further, the at least one wing member 122 extends generally transversely to the longitudinal axis L, projecting generally radially outwardly away from the distal end 120 of the implant body 112, from its wing root 124 where the at least one wing member 122 essentially merges with the implant body 112, to its distal wing end 126, and may arcuately or angularly extend peripherally from a leading end 1271 to a trailing end 127t as can best be appreciated from FIGS. 12-15. The leading end 1271 is disposed circumferentially forwardly along the threading-in direction Ti relative to the trailing end 127t. The at least one wing member 122 projects beyond the diametrical extent Db of the implant body 112 at the distal end 120 and may comprise discontinuous circumferential sections, each one of which spans an arcuate or angular extent “A” which extends peripherally along the circumferential extent “C” of the entire wing member 122, as can best be appreciated from FIG. 15, wherein each sectional extent “A” of each wing section forms only a fractional portion of the entire circumferential extent “C” of the entire wing member 122.

As can best be appreciated still further from FIG. 15, yet another exemplary embodiment of the wing implant 110 is illustrated wherein, for example, different sections of the at least one wing member 122 are located at different axial positions along, or with respect to the longitudinal axis L, and may also be staggered circumferentially around the distal end 120 of the implant body 112. Still further, all of the wing sections may be disposed along a single helical or spiral locus.

During an implant procedure, an exemplary method of enhancing the stability of the winged implant 110 may be employed. According to such an exemplary method, the implant body 110 may be provided with the at least one wing member 122 extending generally away from the wing implant body 112 adjacent to the distal end 120 thereof. When the winged implant 110 is implanted, for example within a crater which may be formed during implant procedure, the implant body 112 may be further supported by the at least one wing member 122, thereby enhancing the stability of the winged implant 110 within the crater of the substrate 116.

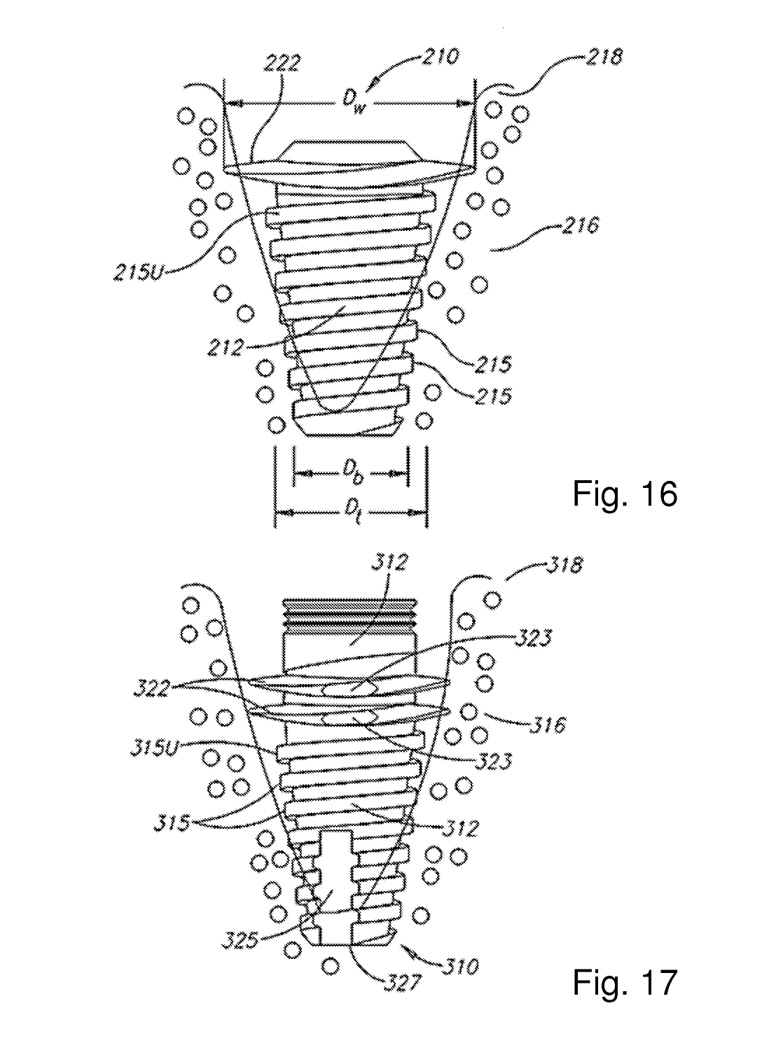

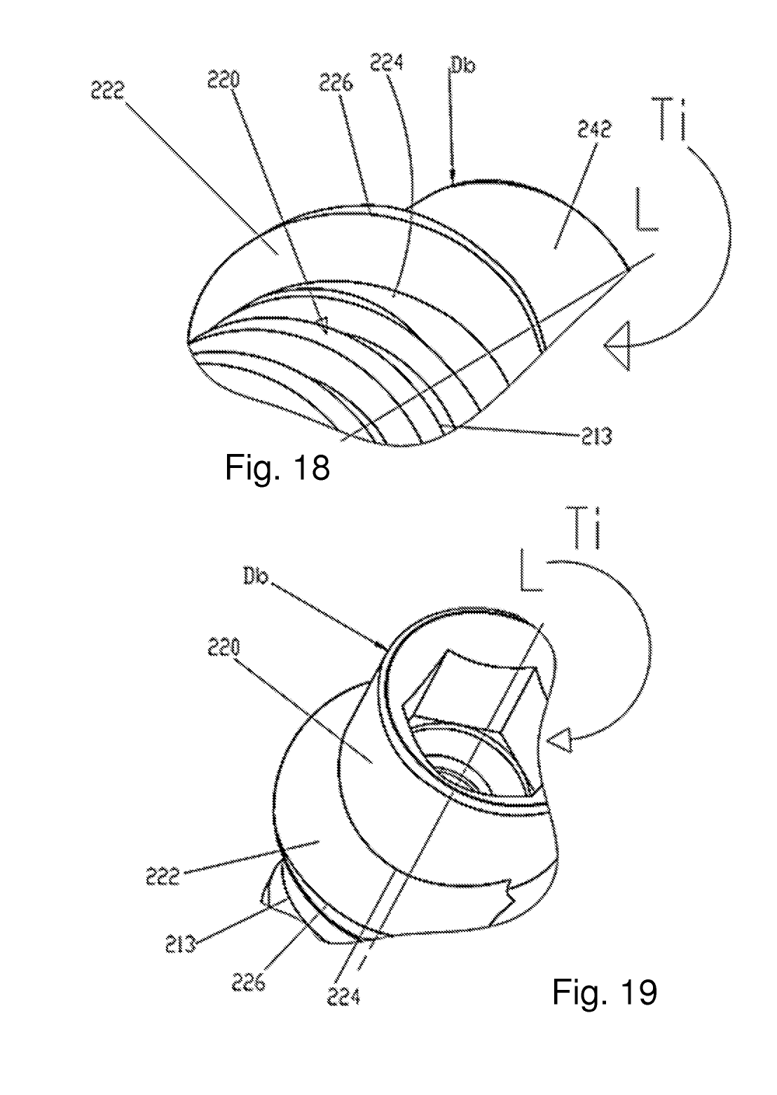

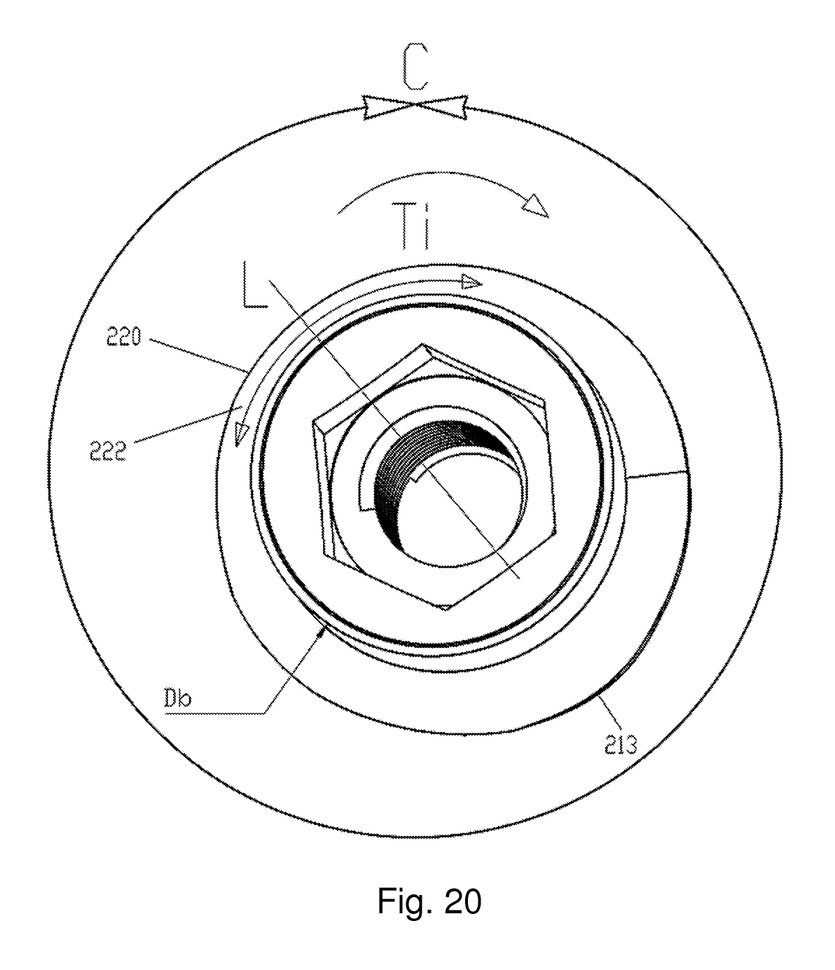

With reference now being made to FIGS. 16 and 18-20, a tenth embodiment of a new and improved implant is illustrated and is designated by the reference character 210. Component parts of the implant 210 which correspond to component parts of the implant 110 are designated by corresponding reference characters except that they will be within the 200 series. As can be appreciated from FIG. 16, the implant 210 comprises an implant body 212 having external threads 215 disposed around the external peripheral surface of the implant body 212. In addition, the implant body 212 is provided with a single, continuous annular wing member 222 which is structured so as to define a smooth continuation of the uppermost external thread 215U. In this manner, when the implant 210 is rotated into the hole or crater of the patient's mouth or oral cavity into which the implant 210 is to be inserted, the external threads 215 of the implant 210 self-taper and threadingly engage and embed themselves within the bone 216 of the oral cavity. In addition, it is also appreciated that the annular wing member 222 may engage and embed itself into the bone and/or osseous tissue portion 218 of the oral cavity so as to in fact stabilize the implant 210 within the implantation site.

As previously noted with respect to prior embodiments of the winged implant 110, the diametrical extent Dw of the wing member 222 is substantially larger than both the diametrical extents Db and Dt of the implant body 212 and external threads 215, respectively, and in particular, the diametrical extent Dw of the wing member 222 may be 20% larger than the diametrical extent Db of the implant body 212.

Lastly, with reference now being made to FIG. 17, an eleventh embodiment of a new and improved implant is illustrated and is designated by the reference character 310. Component parts of the implant 310 which correspond to component parts of the implants 110, or 210 are designated by corresponding reference characters except that they will be within the 300 series. More particularly, it is shown that in accordance with the teachings of the eleventh embodiment implant 310, there is provided a pair of discontinuous annular wing members 322 wherein the discontinuities are disclosed at 323. In this manner, each wing member section can encompass a predetermined arcuate extent “A” as was disclosed within the previous embodiments of the wing members 112 (for instance as shown in FIG. 15). A flute 325 may also be provided upon the leading or apical end 327 of the implant 310 so as to facilitate initial cutting into the bone and/or osseous tissue.

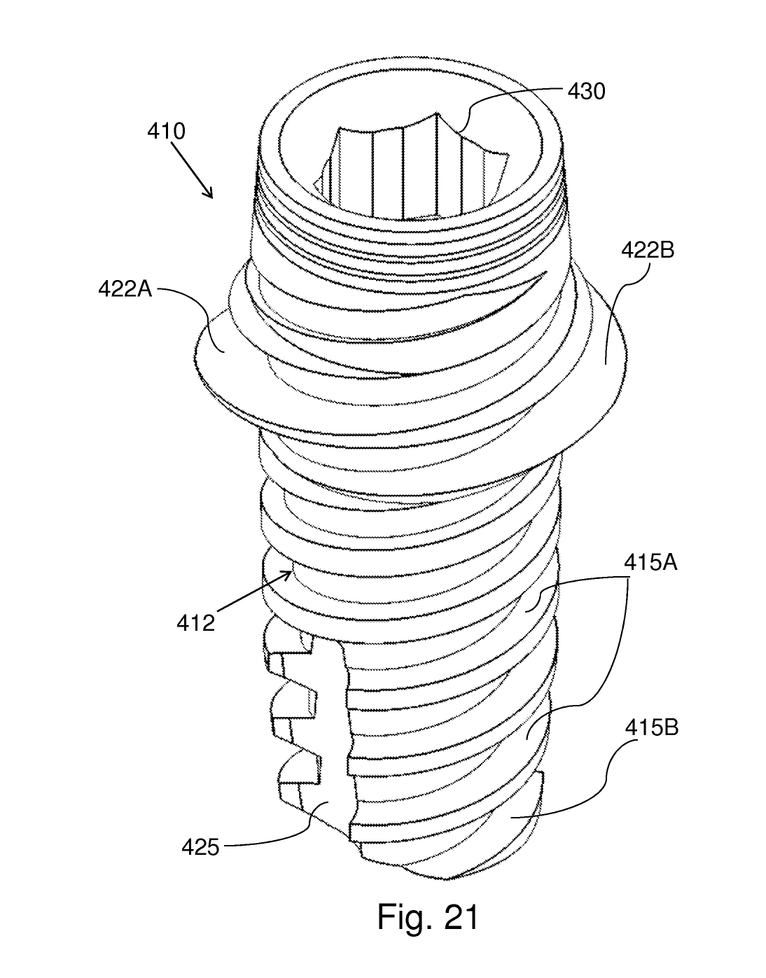

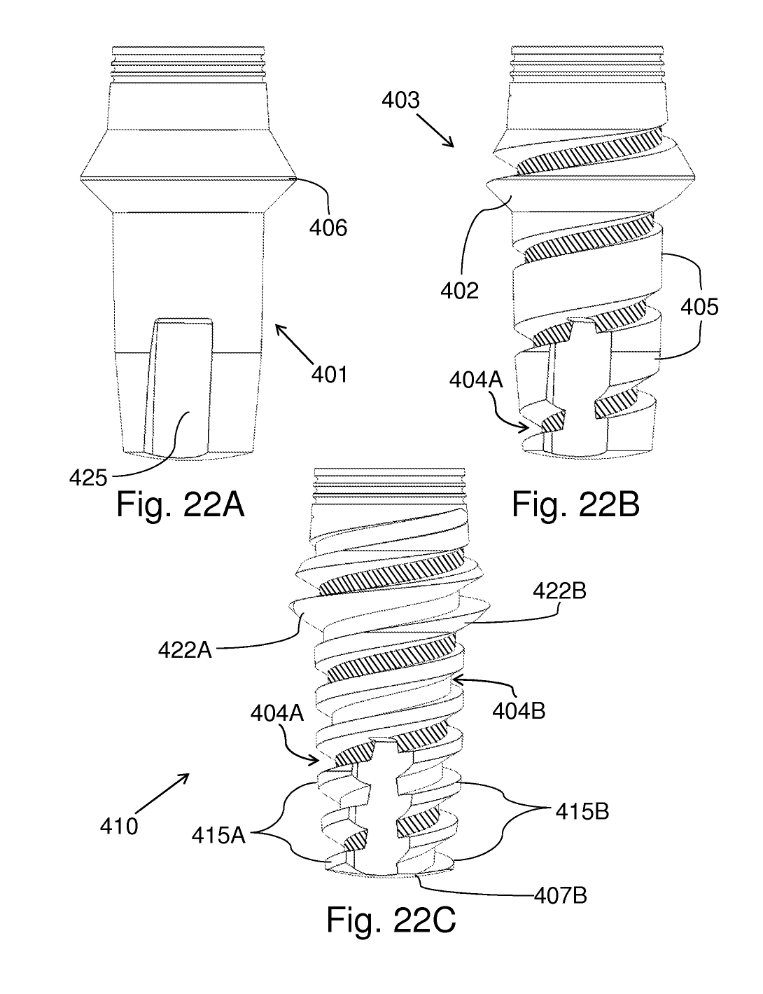

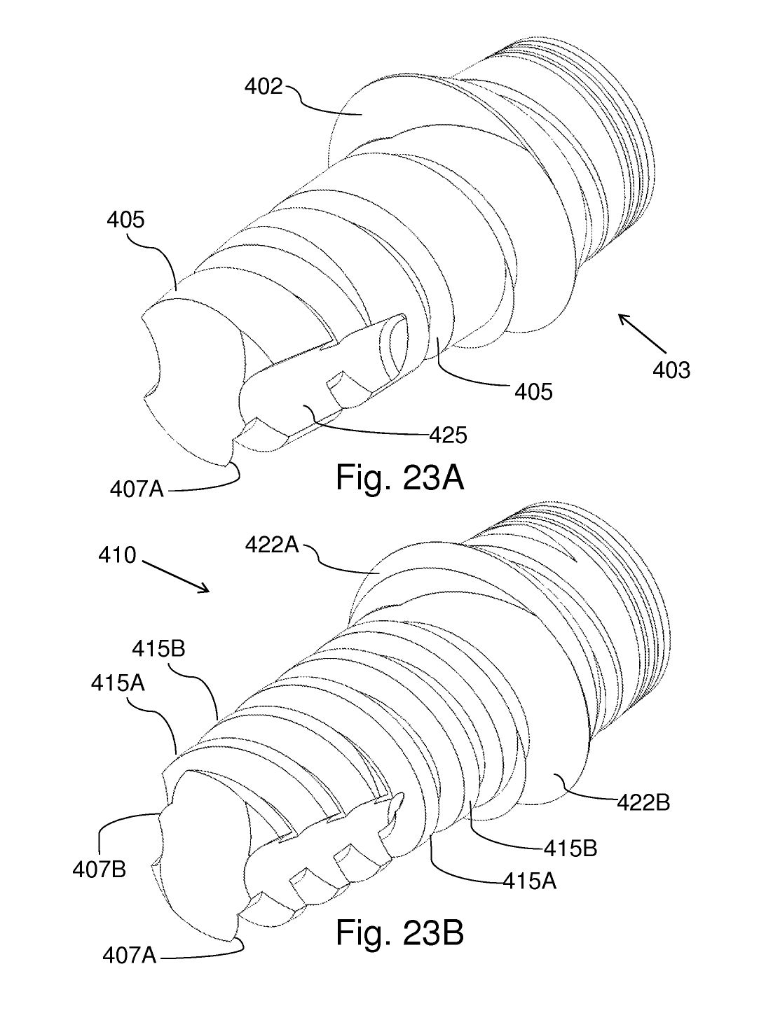

With reference now being made to FIGS. 21-23B, a twelfth embodiment of an additional improved implant is illustrated and is designated by the reference character 410. Component parts of the implant 410 which correspond to component parts of the implant 110 are designated by corresponding reference characters except that they will be within the 400 series. As can be appreciated from FIG. 21, the implant 410 comprises an implant body 412 having a first external threading 415A, and a second external threading 415B, disposed around the external peripheral surface of the implant body 412, further described in FIGS. 22A-23B. Optionally, a flute 425 may also be provided upon the leading or apical end of the implant 410 so as to facilitate initial cutting into the bone and/or osseous tissue.

The first external threading 415A and the second external threading 415B are disposed parallel to each other, such that a continuous annular wing member is created and continuing from each of these external threads. The first external threading 415A continues as a first wing member 422A and the second external threading 415B continues as a second wing member 422B. Since the first external threading 415A and the second external threading 415B are disposed parallel to each other, the first wing member 422A and the second wing member 422B are also disposed parallel to each other. It is also appreciated that the annular wing members 422A, 422B may engage and embed themselves into the bone and/or osseous tissue portion of the oral cavity so as to stabilize the implant 410 within the implantation site.

Referring now to FIGS. 22A-22C and 23A-23B, the structures of the first external threading 415A, the first wing member 422A, the second external threading 415B, and the second wing member 422B are described. FIG. 22A illustrates a frontal view of the twelfth embodiment of the winged implant in an initial state 401. In the initial state 401, the winged implant has a protruding segment 406 and no external threads. After corrugation of the winged implant body, the wing members may be created from the protruding segment 406, further described hereinafter. It should be noted that the protruding segment 406 may be positioned at different locations in the implant 410, such that the wing members may also be created at different locations in the implant 410.

FIG. 22B illustrates a frontal view of the twelfth embodiment of the winged implant in an intermediate state 403. In the intermediate state 403, the winged implant is corrugated with a first annular corrugation 404A (marked for illustrative purposes with a line pattern filling). The first corrugation 404A commences from a first base 407A (shown in FIGS. 23A-23B), and creates an intermediate external threading 405, and an intermediate wing member 402. To get the first external threading 415A, the first wing member 422A, the second external threading 415B, and the second wing member 422B, an additional corrugation is required.

FIG. 22C illustrates a frontal view of the twelfth embodiment of the winged implant in a final state 410. In the final state 410, the winged implant is corrugated with a second annular corrugation 404B (shown without a line pattern filling). The second corrugation 404B commences from a second base 407B, and further corrugates the intermediate external threading 405, and the intermediate wing member 402 to create the first external threading 415A, the first wing member 422A, the second external threading 415B, and the second wing member 422B.

FIG. 23A illustrates a perspective view of the twelfth embodiment of the winged implant in an intermediate state 403, and FIG. 23B illustrates a perspective view of the twelfth embodiment of the winged implant in a final state 410. It should be noted that the first base 407A is positioned opposite to the second base 407B such that the first external threading 415A is parallel to the second external threading 415B. Thus, the winged implant may have two parallel wing members extending generally away from the wing implant body such that when the winged implant 410 is implanted, for example within a crater which may be formed during implant procedure, the implant body may be further supported by the at least two wing members 422A, 422B thereby enhancing the stability of the winged implant.

In a further embodiment, the first wing member 422A and/or the second wing member 422B comprise discontinuous wing member sections and are thus discontinuous annular wing members. In this manner, each wing member section can encompass a predetermined arcuate extent “A”, as was disclosed within the previous embodiments of the wing members 122 (for instance as shown in FIG. 15).

Obviously, many variations and modifications of the present invention are possible in light of the above teachings. It is therefore to be understood that within the scope of the appended claims, the present invention may be practiced otherwise than as specifically described herein.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A winged implant for implantation within osseous tissue or bone, comprising:
an implant body having a first external threading, and a second external threading parallel to the first external threading;
a first wing member projecting radially outwardly of said implant body, as a continuation of said first external threading;
a second wing member projecting radially outwardly of said implant body, as a continuation of said second external threading;
wherein said first wing member and said second wing member extend annularly around said implant body.

2. The winged implant as set forth in claim 1, wherein at least one of said first wing member and said second wing member extends continuously around said implant body.

3. The winged implant as set forth in claim 1, wherein at least one of said first wing member and said second wing member extend discontinuously around said implant body.

4. The winged implant as set forth in claim 1, wherein at least one of said first wing member and said second wing member has a cross-sectional configuration narrowing from a wing root to a wing tip.

5. The winged implant as set forth in claim 1, wherein at least one of said first wing member and said second wing member comprises a plurality of wing sections.

6. The winged implant as set forth in claim 5, wherein each one of said plurality of wing sections is located at a different axial position as measured longitudinally from said implant body.

7. The winged implant as set forth in claim 5, wherein each one of said plurality of wing sections is staggered axially relative to said implant body.

8. The winged implant as set forth in claim 5, wherein each one of said plurality of wing sections is staggered circumferentially relative to said implant body.

9. The winged implant as set forth in claim 5, wherein each one of said plurality of wing sections is staggered circumferentially relative to said implant body, and wherein said plurality of circumferentially staggered wing sections are disposed upon a helix.

10. The winged implant as set forth in claim 1, wherein said implant body has a distal end portion with a socket portion so as to accommodate a tool for imparting rotation to said implant.

11. The winged implant as set forth in claim 1, wherein said implant body is formed with a threaded receptacle for receiving a threaded screw or bolt.

12. The winged implant as set forth in claim 1, wherein said implant body further comprises a fluke so as to facilitate initial cutting into the bone or osseous tissue.

13. A method for implanting an implant within osseous tissue or bone with enhanced stability, the method comprising the steps of:
providing a winged implant, comprising:
an implant body having a first external threading, and a second external threading parallel to the first external threading;
a first wing member projecting radially outwardly of said implant body, as a continuation of said first external threading;
a second wing member projecting radially outwardly of said implant body, as a continuation of said second external threading, wherein said first wing member and said second wing member extend annularly around said implant body; and
rotating said implant body in a threading-in direction during an implant procedure,
wherein said implant body is implanted within the osseous tissue or bone as a result of said first external threading and said second external threading effectively cutting and defining female threads within the osseous tissue or bone, and wherein said first wing member and said second wing member also cut into the osseous tissue or bone so as to support said implant body, thereby enhancing the stability of said implant within the osseous tissue or bone.

14. The method as set forth in claim 13, wherein said implant body has a distal end portion with a socket portion such that the rotation of the implant body is carried out with a tool accommodated in the socket portion.

15. A method for implanting an implant within osseous tissue or bone with enhanced stability, the method comprising the steps of:
providing an implant body having a protruding segment extending annularly around said implant body; and
rotating said implant body in a threading-in direction during an implant procedure,
wherein said protruding segment cuts into the osseous tissue or bone so as to support said implant body, thereby enhancing the stability of said implant within the osseous tissue or bone.

16. The method as set forth in claim 15, further comprising corrugating the implant body with a first annular corrugation to create an intermediate external threading and an intermediate wing member.

17. The method as set forth in claim 16, further comprising corrugating the implant body with a second annular corrugation to create a first external threading, a first wing member, a second external threading, and a second wing member.
